(19) United States
(12) Patent Application Publication
(10) Pub. No.: US 2019/0318435 A1
(43) Pub. Date: Oct. 17, 2019

(54) Integrated Legal Service Coordination and Optimization Systems

(71) Applicant: Karina I De La Cruz, Lake Worh, FL (US)

(72) Inventor: Karina I De La Cruz, Lake Worh, FL (US)

(21) Appl. No.: 16/361,583

(22) Filed: Mar. 22, 2019

Related U.S. Application Data
(60) Provisional application No. 62/648,438, filed on Mar. 27, 2018.

(51) Int. Cl. G06Q 50/18; G06F 17/28; G06T 19/00; G06F 21/32

(52) U.S. Cl. CPC G06Q 50/18; G06F 17/289; G06K 9/00288; G06F 21/32; G06T 19/003

(57) ABSTRACT

An integrated legal service coordination and optimization system is provided. The system includes a legal service coordinator module configured to provide legal service coordinators access to legal service providers. The system also includes a legal service provider module configured to identify available legal service providers. Further, the system also includes a legal service compatibility module configured to assess certification and authentication of credentials and/or social compatibility between the parties. Additionally, the system includes a legal institution module configured to assess compliance with jurisdictional requirements. The system also includes a communication interface, by a data processor, for the modules to interact iteratively and communicate to coordinate time, geographical constraints, social compatibility, jurisdictional authority and to provide legal service coordination and optimization.

### CROSS-REFERENCE TO RELATED APPLICATIONS

This application claims priority to provisional application 62/648,438 filed on Mar. 27, 2018, and is incorporated herein by reference in its entirety.

Reference to Application source code, rules, and components in appendix

The material included in Appendix A is incorporated herein by reference in its entirety.

### Field of the Invention

The present invention relates generally to legal service representation systems, and more particularly, to integrated legal service coordination and optimization systems.

### Background of the Invention

Many methods have been used attempting unsuccessfully to provide effective legal representation, with all required legal support services, in various jurisdictions. Several devices and methods have been created but have failed to rectify the problem of not having the proper services and/or entities available at a specific time and place to convene legal proceedings. These procedures and devices have been deployed in vain to prevent the unavailability of a lawyer, legal support staff, legal support service, and/or required logistical service, to be present when needed. These attempts have not proven to be reliable or effective.

Legal institutions are taxed and are routinely inefficient in serving their respective communities because of improper coordination of legal services and legal support service providers, for example, failing to coordinate process servers, foreign language interpreters, court reporters, expert witnesses, specialized lawyers, and/or videographers quite often lead to having to reschedule legal proceedings and in many cases renders affected parties with unfavorable disposition in court proceedings. This leads to the delayed completion of legal processes, delayed justice, increased costs to the governmental institutions, legal service providers, and legal support service providers, and adverse verdicts for those parties affected. Prior attempts at rectifying this problem have not provided solutions. These inefficiencies increase labor hours and costs for providing legal services in all jurisdictions.

Therefore, there is an established need to solve at least one of the aforementioned problems. Accordingly, there is an established need for legal service coordination to minimize legal costs, reduce inefficiencies, reduce time required for delivery of proper legal resolution, and for better pairing of service providers with service coordinators. Further, there is an established need for an integrated legal service coordination and optimization system which can pair up service providers and service coordinators to provide access to justice for all.

### SUMMARY OF THE INVENTION

The present invention is directed to a convenient and labor-saving, cost saving method, device, and systems to coordinate, optimize, and deliver integrated legal services, which can be used in various legal jurisdictions.

These systems are used to allow legal service seekers to obtain legal remedies without undue delay. Further, these systems are scalable.

According to an aspect of the present invention, an integrated legal service coordination and optimization system is provided. The system includes a legal service coordinator module configured to provide legal service coordinators access to legal service providers. The system also includes a legal service provider module configured to provide availability of the legal service providers to the legal service coordinators by the legal service coordinator module. The system further includes a legal service provider compatibility module configured to provide the legal service coordinators and the legal service providers capability to assess social, cultural, and subject matter compatibility by the legal service coordinator module and the legal service provider module. Additionally, the system includes a legal institution module configured to assess professional competency, jurisdictional authorization to perform services, fitness for deployment in a legal proceeding, and compliance with jurisdictional requirements for the legal service providers. Further still, the system includes a communication interface, by a data processor, for the legal service coordinator module, the legal service provider module, the legal service provider compatibility module, and the legal institution module to iteratively interact and communicate to coordinate time, geographical constraints, social compatibility, jurisdictional authority, and to provide legal service coordination and optimization.

According to another aspect of the present invention, a computer system configured to iteratively interact and communicate amongst users to coordinate time, geographical constraints, social compatibility, jurisdictional authority, and to provide legal service coordination and optimization is provided. The system includes a legal service coordinator module configured to provide legal service coordinators access to legal service providers. The system also includes a legal service provider module configured to provide availability of the legal service providers to the legal service coordinators by the legal service coordinator module. The system further includes a legal service provider compatibility module configured to provide the legal service coordinators and the legal service providers capability to assess social, cultural, and subject matter compatibility by the legal service coordinator module and the legal service provider module. Additionally, the system includes a legal institution module configured to assess professional competency, jurisdictional authorization to perform services, fitness for deployment in a legal proceeding, and compliance with jurisdictional requirements for the legal service providers. Further still, the system includes a communication interface, by a data processor, for the legal service coordinator module, the legal service provider module, the legal service provider compatibility module, and the legal institution module to iteratively interact and communicate to coordinate time, geographical constraints, social compatibility, jurisdictional authority, and to provide legal service coordination and optimization.

According to yet another aspect, a computer implemented method for iteratively interacting and communicating amongst users to coordinate time, geographical constraints, social compatibility, jurisdictional authority, and to provide legal service coordination and optimization is provided. The method includes coordinating legal service coordinators with a legal service coordinator module configured to provide legal service coordinators access to legal service providers. The method also includes providing legal service providers with a legal service provider module configured to provide availability of the legal service providers to the legal service coordinators by the legal service coordinator module. Further, the method includes assessing user compatibility with a legal service provider compatibility module configured to provide the legal service coordinators and the legal service providers capability to assess social, cultural, and subject matter compatibility by the legal service coordinator module and the legal service provider module. Further still, the method includes authenticating legal service providers with a legal institution module configured to assess professional competency, jurisdictional authorization to perform services, fitness for deployment in a legal proceeding, and compliance with jurisdictional requirements for the legal service providers. Additionally, the method includes communicating amongst system users with a communication interface, by a data processor, for the legal service coordinator module, the legal service provider module, the legal service provider compatibility module, and the legal institution module to iteratively interact and communicate to coordinate time, geographical constraints, social compatibility, jurisdictional authority, and to provide legal service coordination and optimization.

In a first implementation of the invention, an integrated legal service coordination and optimization system provides for finding and hiring interpreters, translators, court reporters, videographers, process servers, expert witnesses, and specially trained lawyers upon demand.

In another aspect, the integrated legal service coordination and optimization system can be utilized on a desktop computer, a mobile communication device, for example, but not limited to, a tablet, a smartphone, an apple watch, virtual reality device, a mobile application and/or any device with capability of video, audio, or holographic communications to synchronize legal service providers with legal service coordinators, legal institutions, and deliver authenticated, court approved, and compatible synchronized legal services when needed.

In yet another aspect, the integrated legal service coordination and optimization system can provide for telephonic, videoconferencing, and/or biometric data exchange between legal service providers, legal service coordinators, and legal institutions to allow efficient and effective deployment of legal services with credentialing verified electronically. In embodiments, the system can include retinal scan, facial recognition, and/or fingerprint authentication protocols to validate identification of service providers.

In another aspect, the integrated legal service coordination and optimization system can provide for real-time communication amongst all interested parties, including but not limited to legal service providers, legal service coordinators, attorneys, paralegals, and legal institutions, sharing geographic location, anticipated time of arrival, track their travel, and/or ability to communicate via videoconference or telephonically.

In yet another aspect, the integrated legal service coordination and optimization system can provide for automatically communicating with an emergency legal representative, upon a catastrophic event, for example, a car accident, a family member passing away, and/or biometric information from a personal fitness monitor indicating that assistance is needed, for example, a heart attack, a stroke, and/or other physical and/or emotional health situations.

In another aspect, interpreters, service coordinators, and/or clients can submit comments regarding an assignment or an interpreter once service is completed. For example, during a real-time legal proceeding, the integrated legal service coordination and optimization system can provide for a communication platform between all parties.

In yet another aspect, the integrated legal service coordination and optimization system can provide methods for all parties to rate the performance of each other.

In another aspect, the integrated legal service coordination and optimization system can provide a platform for all parties to submit personal and/or professional profiles, grant access to all parties to authenticated governmental and/or official websites with real-time validation of credentials for a plurality of jurisdictions including but not limited to, federal, state and/or county authorities. The system can also include access for all parties to include, but not limited to, photographs, resumes, professional references, video testimonials, and/or videos of themselves, to effectively pair up clients, legal service providers, support service providers, and/or legal institutions.

In yet another aspect, the integrated legal service coordination and optimization system can incorporate legal glossaries, legal reference guides, for all languages into the platform to allow all parties access.

In another aspect, the integrated legal service coordination and optimization system can provide scheduled communications sessions amongst and/or within each category of users of the system.

In yet another aspect, the integrated legal service coordination and optimization system can provide continuing education credits for teaching and training sessions which have been approved by the applicable jurisdiction. In aspects, the system can include authenticated reporting and logging of training and education that has been conducted, within a plurality of jurisdictions with the official body in charge of tracking the training and education.

In another aspect, the integrated legal service coordination and optimization system can provide a forum for attorneys to discuss current issues relevant to their jurisdiction.

In another aspect, the integrated legal service coordination and optimization system can provide authentication processes including but not limited to facial recognition, retinal identification, fingerprint identification, and/or biometric data for all participants of the system.

In yet another aspect, the integrated legal service coordination and optimization system can provide a platform wherein interaction between legal service providers, attorneys, paralegals, legal support services, auxiliary service providers, and/or legal institutions can take place and appropriate choices made with respect to coordination of legal services taking into consideration, but not limited to, personal chemistry, topics that are being resolved, gender, cultural, ethnic, religious, and other personal characteristics which may influence the effectiveness and efficiency of the parties involved. In aspects, the system compatibility amongst users and service providers is augmented by real-time video and/or telephonic interaction.

In another aspect, the integrated legal service coordination and optimization system can maintain a database of all participants and provide an ongoing rating system to allow all participants to view ratings from interactions from others within the systems.

In yet another aspect, the integrated legal service coordination and optimization system can communicate with users when a derogatory rating has been logged and provide an opportunity to rectify the rating.

In another aspect, the integrated legal service coordination and optimization system utilizes algorithms, source code, rules, and components to allow the real-time functionality of the system to be enhanced.

In yet another aspect, the integrated legal service coordination and optimization system utilizes algorithms, source code, rules, and components to provide accurate and verifiable authentication before various jurisdictions.

In another aspect, the integrated legal service coordination and optimization system utilizes algorithms, source code, rules, and components in mobile devices to provide for real-time functionality of the system.

In yet another aspect, the system can include mobile applications, the mobile applications functional on a plurality of mobile devices.

In another aspect, the system can include a real-time language translation interface, wherein the interface is configured to translate written and spoken communication expressed in a language into a plurality of languages.

In yet another aspect, the system can include a legal jurisdiction interface, the interface configured to provide authenticated, court approved, and compatible synchronized legal services when needed.

In another aspect, the system can include a biometric interface, the interface configured to provide real-time system user authentication and certification capability.

In yet another aspect, the system can also include a foreign language legal glossaries interface, the interface configured to provide users with real-time access to foreign language legal glossaries.

In another aspect, the system can include a computer system configured to iteratively interact and communicate amongst users to coordinate time, geographical constraints, social compatibility, jurisdictional authority, and to provide legal service coordination and optimization.

In yet another aspect the system can also include a mobile application, wherein the mobile application is configured to provide real-time communication for system users.

In another aspect, the system can include a facial recognition interface, wherein the interface is configured to authenticate users on the system.

In yet another aspect, the system can include a facial recognition interface, wherein the interface is configured to authenticate users on the system.

In another aspect, the system can include a virtual reality interface, the interface configured to augment assessment of social compatibility amongst users of the system.

In yet another aspect, the system can also include a training and education interface, the interface configured to provide authenticated reporting and logging of training and education that has been conducted, within a plurality of jurisdictions with an official body in charge of tracking the training and education.

In another aspect, the system can include a legal jurisdiction interface, the interface configured to provide authenticated, court approved, and compatible synchronized legal services when needed by a system user.

In yet another aspect, the system can also include biometric interface, the interface configured to provide real-time system user authentication and certification capability.

In another aspect, the system can include a foreign language legal glossaries interface, the interface configured to provide users with real-time access to foreign language legal glossaries.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a functional block diagram in accordance with an embodiment of the present invention;

FIG. 2 presents an embodiment of the present invention displaying the legal service providers module;

FIG. 3 presents an embodiment of the present invention displaying the legal services compatibility module;

FIG. 4 presents an embodiment of the present invention displaying the legal institution module;

FIG. 5 presents an embodiment of the present invention displaying the legal services coordinator module;

FIG. 6 presents an embodiment of the present invention displaying legal service coordination and optimization system; and

FIG. 7 presents an embodiment of the present invention displaying various embodiments on platforms connected on a communications network.

### DETAILED DESCRIPTION

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

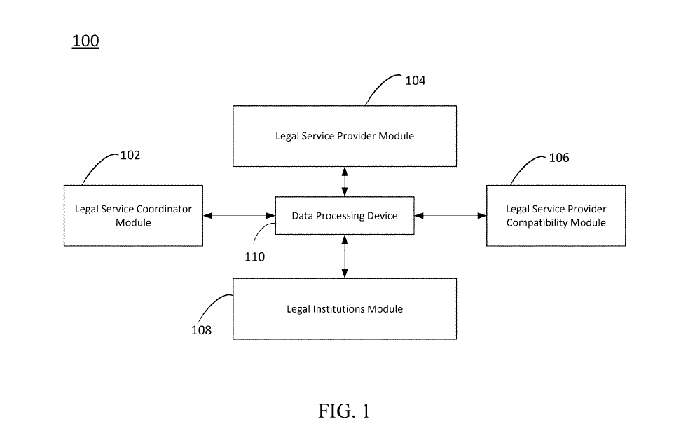

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

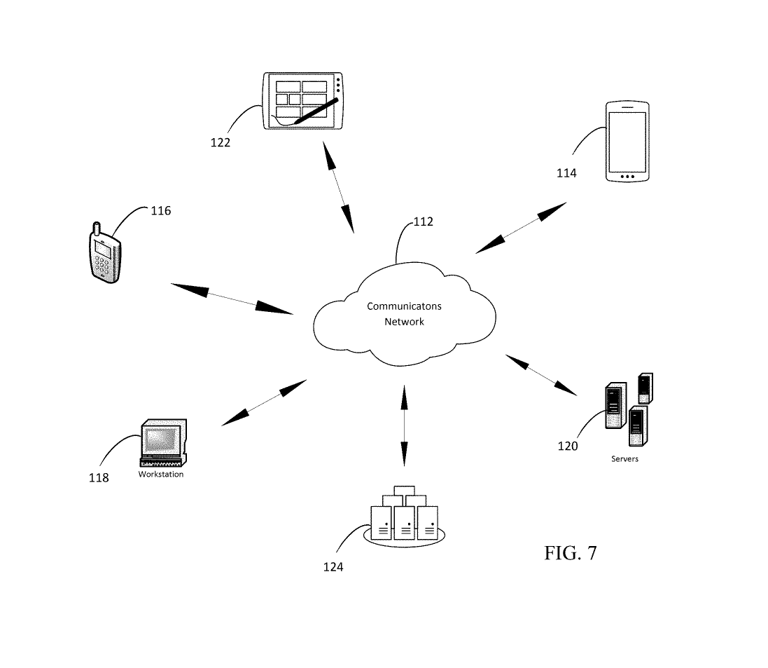

Referring initially to FIGS. 1 and 7, an exemplary embodiment of the present invention is presented. An embodiment of an integrated legal service coordination and optimization system 100 is shown. The system 100 can include a legal service coordinator module 102. The system 100 can also include a legal service provider module 104. Further, the system 100 can include a legal service provider compatibility module 106. Additionally, the system 100 can include a legal institutions module 108. Further yet, the system 100 can include a data processor 110, the data processor 100 configured to reside on a plurality of platforms and to provide real-time communication amongst the modules, 102, 104, 106, and 108 to provide legal service coordination and optimization. The system 100 can be configured to provide real-time interaction between the modules 102, 104, 106 and 108 functioning on a plurality of platforms wherein a plurality of data processors 100 operate.

As best seen in FIG. 7, an embodiment of the system 100 is illustrated wherein a plurality of interface devices can be utilized to provide communication across a plurality of communications networks. The legal service coordinators, working alongside clients and other interested parties interact with the system 100 to coordinate legal service providers. The platforms utilized can be smartphones 114, cell phones 116, workstations 118, servers 120, a tablet and/or mobile device 122, and/or devices 124 which provide communication capability to the system in order to allow all system users to interact, validate, authenticate, and/or check for compatibility amongst users to coordinate services. All platforms utilize algorithms, source code, rules, and/or components which allow real-time communication amongst all parties communicating on the system 100 and provide for coordination and optimization of legal services.

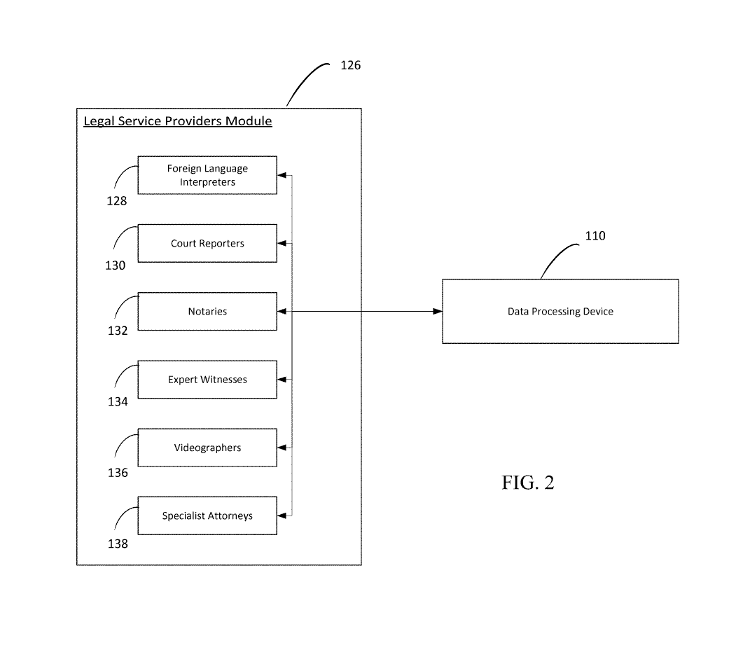

Turning to FIG. 2, an embodiment of present invention is presented, displaying the legal service provider module 126. The legal service provider module 126 interacts with all users of the system 100 and presents available legal service providers to coordinate and pair up services, including but not limited to, foreign language interpreters 128, court reporters 130, notary public 132, expert witnesses 134, videographers and/or stenographers 136, and/or specialist attorneys 138. In embodiments of the system 100, the legal service provider module can be configured to allow legal service providers to interface with the system 100 to qualify, validate, authenticate, and/or detail parameters of services provided. In embodiments not shown, legal service providers can include, process servers, mediators, and/or paralegals. For example, a foreign language interpreter 128 who is proficient in a specific language can, through the system, register to offer their services. Further the interpreter, through the system 100, can detail the types of services and availability geographically and/or on a time basis. Additionally, the interpreter 128 can, through the system, authenticate credentials with jurisdictional authorities. Further still, the interpreter 128 can through the system 100 validate proficiency in their language with interaction with certification authorities. Also, the interpreter 128 through the system 100 can interact in real-time with other users, using a plurality of communication methods, through the system 100 to check for compatibility and for deployment for an assignment. The system 100 can be configured to provide a plurality of legal service providers interaction with the system 100 with the legal service provider module 126 and in similar fashion, authenticate, validate, and certify that the legal service providers meet the criteria for the local legal jurisdiction. The system can be configured to geographically locate service providers and system 100 users such that the location of all system 100 users can be shared and displayed amongst all users of the system 100.

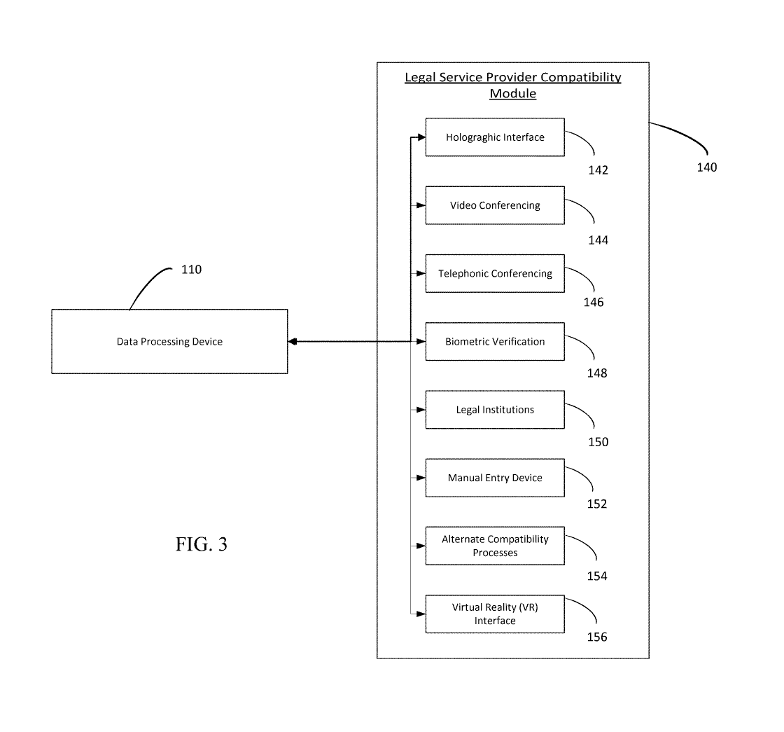

As illustrated in FIG. 3, the legal service provider compatibility module 140 is displayed. The compatibility module 140 includes, but not limited to, devices and communication mediums configured to provide all system 100 users capability to conduct holographic interfacing 142, video conferencing 144, telephonic conferencing 146, biometric verification 148 of personnel, legal institution 150 authentication of credentials, manual entry device 152 input from certified personnel, alternate compatibility assessment processes 154, and/or virtual reality (VR) 156 to allow system 100 users real-time iterative interaction capability to augment compatibility assessment amongst users. These alternate compatibility processes 154 include, but are not limited to, algorithms, source code, rules, and/or components, facial recognition software, to discern and/or to determine social compatibility between users of the system 100, voice and social interaction capabilities to allow users to determine if compatibility is met for all parties. These processes also include consideration of the legal issues involved, including, but not limited to, gender and age of clients, trauma experienced by the clients, and/or emotional disposition of the clients. For example, the compatibility module 140 can be accessed by all users at all phases of interaction to pair up service providers and service coordinators.

Further, the compatibility module 140 affords sensitive legal processes to proceed while mitigating harm to clients who have experienced trauma. For example, many legal proceedings involve emotionally sensitive subject matter involving young children, marginalized communities, ethnic and/or culturally diverse populations which require cultural sensitivity. Many of these parties are victims of sexual assault and other heinous and other emotionally disturbing experiences. To best serve these communities, the system 100 can be configured to provide interaction between all users to better assess compatibility and subject matter sensitivity.

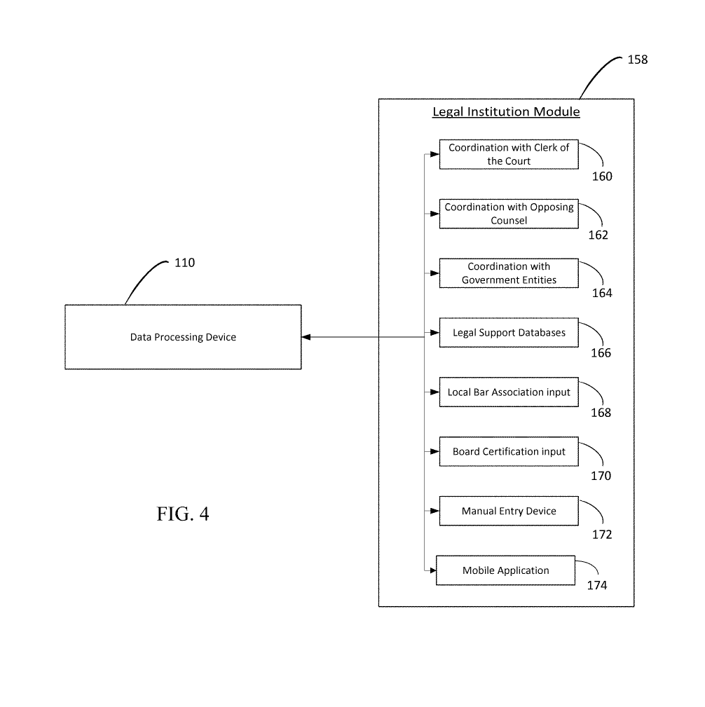

As shown in FIG. 4, a legal institution module 158 is displayed. The system 100 can be configured with capability for legal institutions to engage with the system 100 to verify, authenticate, and/or validate legal service providers and/or to confirm scheduled legal proceedings. The legal institution module can include the capabilities of coordination with the clerk of the court 160, coordination with opposing counsel 162, coordination with governmental entities 164, accessing legal support databases 166, engaging with local bar associations 168 for verification of credentials and/or logging expertise and/or legal training and education, board certification input 170, manual entry device 172 for authorized entities to engage with the system to manually enter data and/or verify data, and/or mobile applications 174 configured to allow authorized users to interact with the system 100. In most jurisdictions, legal rules and regulations vary. To best coordinate deployment of legal services, local bar associations 168, board certification entities 170, other governmental agencies 164 may contribute information via databases to authenticate legal support services.

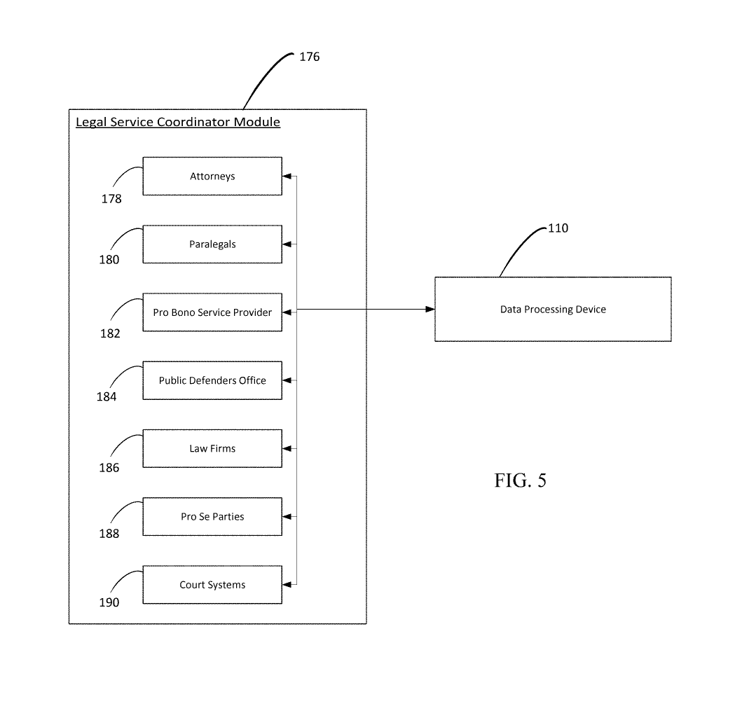

As displayed in FIG. 5, the system 100 can include a legal service coordinator module 176. The coordinator module 176 can be configured to provide access to a plurality of users who are in a position to assess, coordinate, and acquire legal service providers. The system 100 can be configured to provide communication mediums to attorneys 178, paralegals 180, pro bono service providers 182, public defenders office 184, law firms 186, pro se parties 188, and/or court systems 190 to engage with other system users to quickly, efficiently, and effectively obtain legal service providers. For example, many legal proceedings require certified proficient language interpreters 128 for a plurality of occasions. The interpreters 128 may need to hold certifications and be authorized to provide their services in certain jurisdictions. Different jurisdictions may have different qualification standards. The system 100 can be configured to identify qualified available and authorized interpreters 128 for a specific geographical and time constraint. Further, the system 100 can be configured to provide system users and interpreters 128 the capability of real-time interaction to assess availability and qualifications, validate certifications, ensure they are qualified by the jurisdiction to provide their services, and to assess compatibility for deployment with respect to a particular legal proceeding. The system 100 had never before existed and solves a long-standing problem in the field of identifying and acquiring interpreters 128 that are a good fit for the legal proceeding and for the clients.

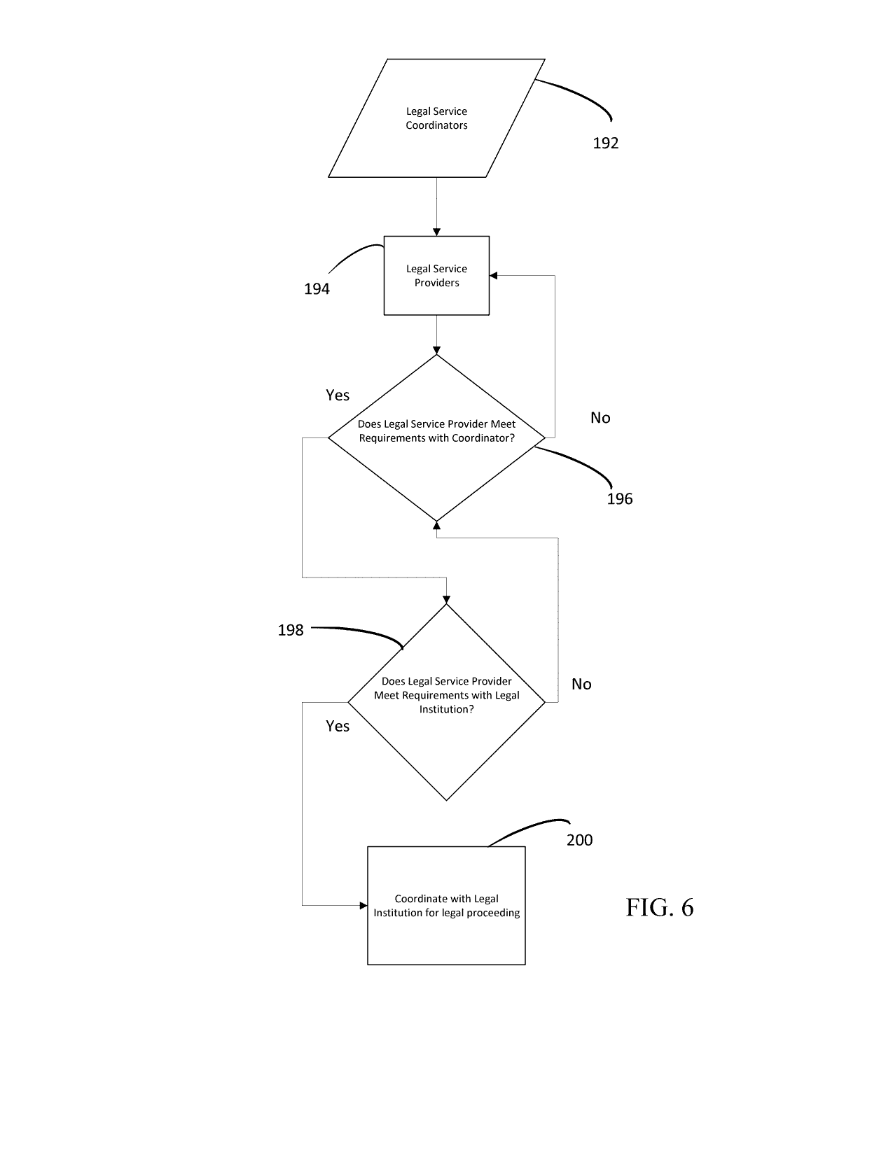

Referencing FIG. 6, an embodiment of the system 100 is displayed wherein a legal service coordination and optimization process occurs. In embodiments, the system 100 can include legal service coordinators 192 who are in need for legal service providers 194. Users of the system 100 can engage with one another to ascertain if the legal service provider meets the requirements of the coordinator 196. The system 100 can also validate whether the legal service provider meets the requirements of the legal institution 198. Further, the system 100 can be configured to allow users to enter into negotiations for costs of services requested and once agreed upon the system can coordinate pairing up of service coordinator and service provider 200.

The system 100 can be configured to provide communication mediums to legal service coordinators who are in need of specific legal service. The coordinators engage with the system 100 and provide logistical requirements for a particular proceeding. For example, an attorney 178 who while on their way to a court hearing may be informed that a pre-arranged interpreter will not be able to attend the proceeding due to a family emergency. The attorney, while in transit to the hearing can engage with the system 100, input their requirements, such as time of the hearing, location of the hearing, jurisdiction, such as Federal or State court, and language proficiency required. The attorney 178 engaging with the system 100, can choose to engage with available interpreters 128 and can communicate in real-time with the interpreter 128 to assess compatibility.

Further, the attorney 178 can engage with the system 100 and utilize other tools, such as video conferencing, and can perform video conferencing between a prospective interpreter 128 and their clients to assess compatibility. Further, the attorney 178 can engage with the system 100 to validate, certify, and authenticate the interpreters 128 ability to provide services in that jurisdiction for that particular hearing. The attorney 178 can engage with the system 100 to acquire the interpreter 128 to perform services and to enter into a contract with the interpreter 128 for a price that is agreed to by all parties. The system 100 can be configured to provide all users an ability to iteratively interact to reach an agreement as to price for services that will be rendered. Also, the system 100 can be configured to allow parties to negotiate a price for services and the system 100 can allow parties to pay and receive funds in accordance with their negotiated agreement.

In embodiments of the system 100, the system 100 can include capability of users to engage in price negotiations for services requested and can allow users to enter into a contract, agree to payment terms, agree to timing, manner, and location of rendering payment on a real-time basis using the system 100, prior to and/or after delivery of services.

In some embodiments, the method or methods described above may be executed or carried out by a computing system including a tangible computer-readable storage medium, also described herein as a data processor, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, flash drives, cloud storage, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. An integrated legal service coordination and optimization system comprising:
a legal service coordinator module configured to provide legal service coordinators access to legal service providers;
a legal service provider module configured to provide availability of the legal service providers to the legal service coordinators by the legal service coordinator module;
a legal service provider compatibility module configured to provide the legal service coordinators and the legal service providers capability to assess social, cultural, and subject matter compatibility by the legal service coordinator module and the legal service provider module;
a legal institution module configured to assess professional competency, jurisdictional authorization to perform services, fitness for deployment in a legal proceeding, and compliance with jurisdictional requirements for the legal service providers; and
a communication interface, by a data processor, for the legal service coordinator module, the legal service provider module, the legal service provider compatibility module, and the legal institution module to iteratively interact and communicate to coordinate time, geographical constraints, social compatibility, jurisdictional authority, and to provide legal service coordination and optimization.

2. The system of claim 1, further comprising a mobile application, wherein the mobile application is configured to provide real-time communication for system users.

3. The system of claim 1, further comprising a real-time language translation interface, wherein the interface is configured to translate written and spoken communication expressed in a language into a plurality of languages.

4. The system of claim 1, further comprising a facial recognition interface, wherein the interface is configured to authenticate users on the system.

5. The system of claim 1, further comprising a virtual reality interface, the interface configured to augment assessment of social compatibility amongst users of the system.

6. The system of claim 1, further comprising a training and education interface, the interface configured to provide authenticated reporting and logging of training and education that has been conducted, within a plurality of jurisdictions with an official body in charge of tracking the training and education.

7. The system of claim 1, further comprising a legal jurisdiction interface, the interface configured to provide authenticated, court approved, and compatible synchronized legal services when needed by a system user.

8. The system of claim 1, further comprising, a biometric interface, the interface configured to provide real-time system user authentication and certification capability.

9. The system of claim 1, further comprising a foreign language legal glossaries interface, the interface configured to provide users with real-time access to foreign language legal glossaries.

10. A computer system configured to iteratively interact and communicate amongst users to coordinate time, geographical constraints, social compatibility, jurisdictional authority, and to provide legal service coordination and optimization, the system comprising:
a legal service coordinator module configured to provide legal service coordinators access to legal service providers;
a legal service provider module configured to provide availability of the legal service providers to the legal service coordinators by the legal service coordinator module;
a legal service provider compatibility module configured to provide the legal service coordinators and the legal service providers capability to assess social, cultural, and subject matter compatibility by the legal service coordinator module and the legal service provider module;
a legal institution module configured to assess professional competency, jurisdictional authorization to perform services, fitness for deployment in a legal proceeding, and compliance with jurisdictional requirements for the legal service providers; and
a communication interface, by a data processor, for the legal service coordinator module, the legal service provider module, the legal service provider compatibility module, and the legal institution module to iteratively interact and communicate to coordinate time, geographical constraints, social compatibility, jurisdictional authority, and to provide legal service coordination and optimization.

11. The system of claim 10, further comprising a mobile application, wherein the mobile application is configured to provide real-time communication for system users.

12. The system of claim 10, further comprising a real-time language translation interface, wherein the interface is configured to translate written and spoken communication expressed in a language into a plurality of languages.

13. The system of claim 10, further comprising a facial recognition interface, wherein the interface is configured to authenticate users on the system.

14. The system of claim 10, further comprising a virtual reality interface, the interface configured to augment assessment of social compatibility amongst users of the system.

15. The system of claim 10, further comprising a training and education interface, the interface configured to provide authenticated reporting and logging of training and education that has been conducted, within a plurality of jurisdictions with the official body in charge of tracking the training and education.

16. The system of claim 10, further comprising a legal jurisdiction interface, the interface configured to provide authenticated, court approved, and compatible synchronized legal services when needed.

17. The system of claim 10, further comprising, a biometric interface, the interface configured to provide real-time system user authentication and certification capability.

18. The system of claim 10, further comprising a foreign language legal glossaries interface, the interface configured to provide users with real-time access to foreign language legal glossaries.

19. A computer implemented method for iteratively interacting and communicating amongst users to coordinate time, geographical constraints, social compatibility, jurisdictional authority, and to provide legal service coordination and optimization, the method comprising the acts of:
coordinating legal service coordinators with a legal service coordinator module configured to provide legal service coordinators access to legal service providers;
providing legal service providers with a legal service provider module configured to provide availability of the legal service providers to the legal service coordinators by the legal service coordinator module;
assessing user compatibility with a legal service provider compatibility module configured to provide the legal service coordinators and the legal service providers capability to assess social, cultural, and subject matter compatibility by the legal service coordinator module and the legal service provider module;
authenticating legal service providers with a legal institution module configured to assess professional competency, jurisdictional authorization to perform services, fitness for deployment in a legal proceeding, and compliance with jurisdictional requirements for the legal service providers; and
communicating amongst system users with a communication interface, by a data processor, for the legal service coordinator module, the legal service provider module, the legal service provider compatibility module, and the legal institution module to iteratively interact and communicate to coordinate time, geographical constraints, social compatibility, jurisdictional authority, and to provide legal service coordination and optimization.

20. The method according to claim 19, further comprising identifying users of the system with a virtual reality interface, the interface configured to augment assessment of social compatibility amongst the users of the system.
